(19) United States
(12) Patent Application Publication
(10) Pub. No.: US 2014/0358812 A1
(43) Pub. Date: Dec. 4, 2014

(54) DYNAMIC INFORMATION SHARING PLATFORM

(71) Applicant: Hitec Luxembourg S.A., Luxembourg (LU)

(72) Inventors: Benjamin Hourte, Gorcy (FR); Simon Massart, Luxembourg (LU)

(73) Assignee: Hitec Luxembourg S.A., Luxembourg (LU)

(21) Appl. No.: 14/291,534

(22) Filed: May 30, 2014

Related U.S. Application Data
(60) Provisional application No. 61/828,998, filed on May 30, 2013.

(51) Int. Cl. H04W 4/22; G06Q 50/26

(52) U.S. Cl. CPC H04W 4/22; G06Q 50/265
USPC 705/325

(57) ABSTRACT

A computer network implemented system for disaster and crisis management which includes at least one server computer, an information collection utility that enables an entity to collect and store information to a database; a communications device for establishing a network corresponding to the communications device; a plurality of communication nodes, each communication node being connected to the network; a user application comprising software for execution by a processor; a message management and routing system configured to facilitate communications; a fixed mode capable of functioning as a crisis center; a user device configured to display information from the user application; where each node of the plurality of nodes is associated with an emergency services source, and is configured to communicate information to the user application; and where the user device is configured to display information regarding the emergency services sector resource from the user application.

### BACKGROUND OF THE INVENTION

The present invention is directed to a cloud based Dynamic Information Sharing Platform (DISP) designed to offer to Public Safety Forces (PSF) different devices coupled with operating software to increase their situational awareness and make their everyday lives safer without requiring any configuration and technical know-how or intensive training. The platform consists of two different kinds of elements, namely different hardware devices that host the software and applications software composed by different modules and services.

The public safety market is currently focused on traditional telecommunication methods, but users demand for more, such as for example, really usable interfaces which are easy to handle and do not impose limitations to their way to work. Public Safety Forces operate in very different environments and conditions, using vehicles, standalone devices and heavy infrastructure. They have to stay flexible as they can be faced with un-planned situations. Furthermore, PSF often are required to work following specific command chains. The transmission of information is usually linked to the command chain, with different levels of hierarchy managing the flow of information (See for example FIG. 1). The lower levels are field personnel reporting to their direct hierarchy and continuing up to the higher level. The higher levels are managing more crises but lower details.

### SUMMARY OF THE INVENTION

A computer network implemented system for disaster and crisis management and for enabling one or more interactions between one or more entities which includes at least one server computer, the server computer including an information collection utility that enables an entity to collect and store to a database linked to the server computer one or more information objects; a communications device configured to establish a communications network corresponding to that communications device; a plurality of nodes, each node being connected to the network established by the communications device; a user application comprising software loaded in a computer readable medium at a computing device for execution by a processor; a message management and routing system configured to facilitate communications between the communication device and the user application; a fixed mode capable of functioning as a crisis center; a user device configured to display information from the user application; where each node of the plurality of nodes is associated with an emergency services sector resource, and is configured to communicate information regarding the emergency services sector resource to the user application via the communications device; and where the user device is configured to display information regarding the emergency services sector resource from the user application.

### BRIEF DESCRIPTION OF THE DRAWINGS

The foregoing and other features and advantages of the present invention will become apparent to those skilled in the art to which the present invention relates upon reading the following description with reference to the accompanying drawings, in which like reference characters refer to like elements through the different figures and in which:

FIG. 1 is a flow diagram showing an example of the chains of command for public safety forces;

FIG. 2 is a flow diagram showing an example of distributed network architecture with different Information Management components;

FIG. 3 is a flow diagram showing an initial middleware network without any information distributed by the management service;

FIG. 4 is a flow diagram showing the registries of the management service filled with the appropriate records of the remote middleware based on the auto-discovery procedure;

FIG. 5 is a flow diagram showing the information management flows for synchronization that arises from the information in the Management Service;

FIG. 6 is a flow diagram showing a information management network and illustrating the effects of the synchronization process;

FIG. 7 is a flow diagram showing a high-level summary of the synchronization between two services;

FIG. 8 is a schematic flow diagram showing the exchange and integration of missionId updates;

FIG. 9 is a flow diagram showing a simple modeling structure for the element managed in the middleware service;

FIG. 10 is a flow diagram showing the difference modeling based on the missionId and its integration;

FIG. 11 is a schematic flow diagram showing the middleware network after the synchronization has been completed without common missions;

FIG. 12 is a schematic flow diagram showing another scenario after synchronization with a mission that includes all middleware but pssu-pc01;

FIG. 13 is a schematic diagram showing integration on an IP network of different Middleware nodes and the related end-users;

FIG. 14 is a schematic diagram showing the registering of the middleware services internally;

FIG. 15 is a schematic diagram showing the different scopes of the multicast network used for the auto-configuration processes; and

FIG. 16 is a schematic diagram showing the multicast flows using SLP (Service Location Protocol) to register services.

### DETAILED DESCRIPTION OF THE INVENTION

The present invention is directed to a method and apparatus which provide a system with architecture and protocols for cloud based disaster and crisis management that will allow for organizing the information management and delivery on a distributed and constraint conditions. The system is preferably based on Mobile Wireless Communication system (MoWiCo) and is designed to be included in mobile vehicles, such as police cars, fire engines, and/or armored vehicles, but is not limited to wireless communications and can be applied to wired communications.

Nomadic Satellite Communication system (NoSaCo) designed as stationary satellite stations are deployed as a telecommunication station. The architecture and protocols of the present invention allow safety forces to manage the distributed infrastructure ensuring the efficiency of the information transfer, improve the quality of telecommunication links between the different teams, improve the auto-configuration and discovery inside the global infrastructure provide flexibility for the mission scope, and improve the level of security of the information to transport and deliver and maintain a global security policy. The concept can also be applied to a man portable system.

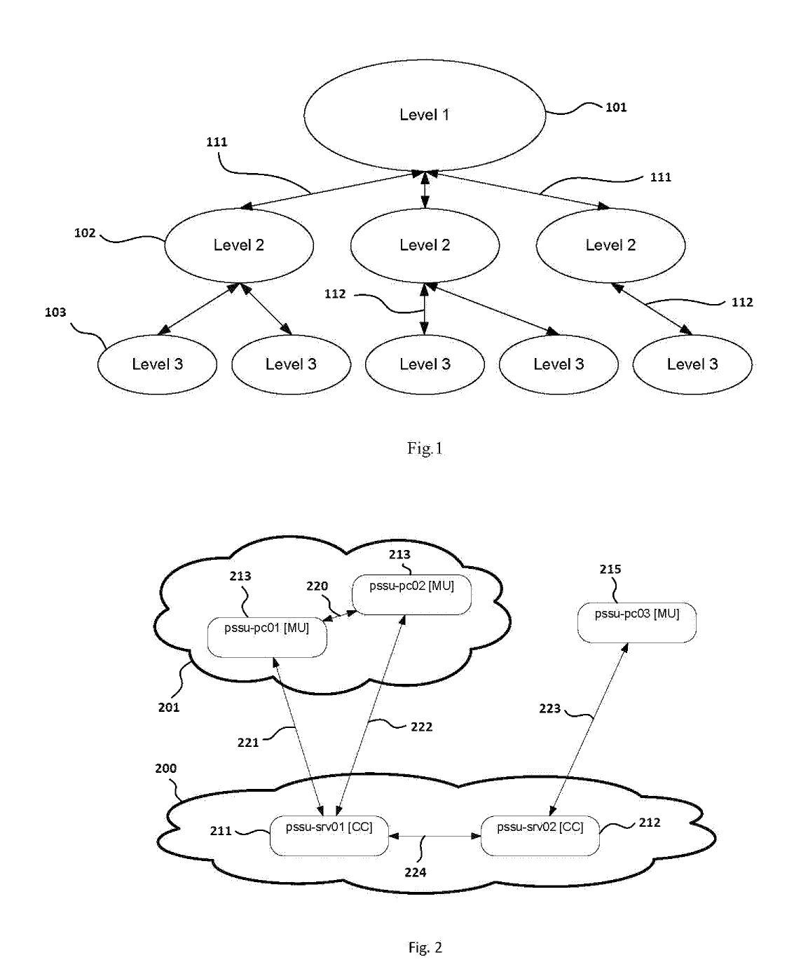

FIG. 1 illustrates a typical command/information hierarchy. The leader 101 issues orders to subordinate managers 102 via high level lines of communication 111. The managers 102 report information back to the leader 101 via the lines of communication 111. The managers also issue orders to their subordinates, such as field operatives 103 via lower level communication lines 112. The field operatives 103 report information back to the mangers 102 via the low level communication lines 112. Thus, information and orders are distributed to the appropriate individual or group.

The method and apparatus of the present invention allows safety forces to organize information, manage the distributed infrastructure ensuring the efficiency of the information transfer, improve the quality of telecommunication links between different teams, improve the auto-configuration and discovery inside the global infrastructure, and provide flexibility for the mission scope and level of security of the information to transport, deliver and maintain a global security policy and delivery on distributed and constraint conditions

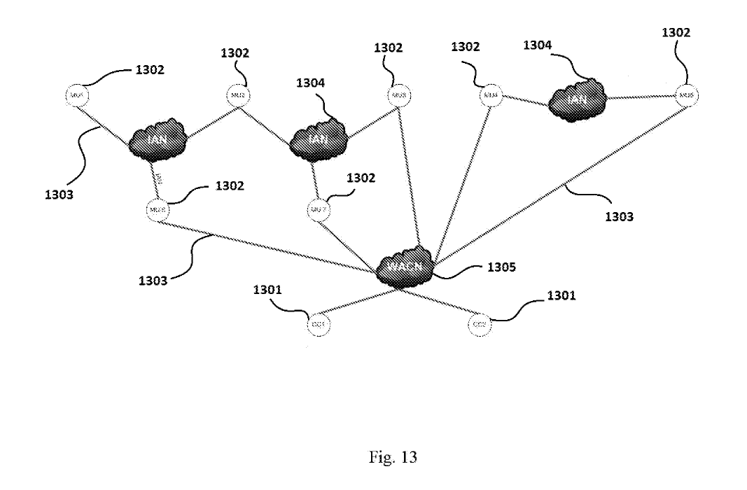

The “cloud approach” used for the information management involves nodes with different roles. In order to provide an efficient way to distribute the information the nodes are acting differently if the nodes are in the field (called MU or Mobile Units 1302 (see FIG. 13) or referred to as nomadic), or at a fixed installation (called CC as Crisis Centre 1301). Based on the required information, the Mobile Units adapt their comportment inside the cloud. They only transfer and manage the required information. The required information scope can evolve according to the mission needs.

According to some metrics, the cloud nodes are adapting their comportment for managing the information. The information is modeled in the cloud in three parts, namely the metadata of the information, including the time stamping, the source, and the like, the payload of the information, including the actual value for a sensor, a map or the actual picture, and the signaling as the means to access the information.

One of the central design properties of the Dynamic Information Sharing Platform (DISP) middleware is the support for distribution. The word “middleware” is meant to include a network of software agents creating an autonomous system transporting information, such as communication systems. This includes having multiple Middleware installations, and especially support for synchronization of the information between the service instances of different middleware installations. The middleware contains a complex process that controls the synchronization of information between multiple installations. The synchronization involves several steps on different levels, and is ultimately controlled by several pieces of information. The differentiation of the middleware installations feature two different types: Crisis Centers (or CC) 1301 and Mobile Units (or MU) 1302, as seen in FIG. 13, and this is the first piece of information that controls the synchronization behavior in general. These two middleware types fulfill different roles in the architecture. The Crisis Center entities are considered as global nodes with large technical capacities, such as network connections, resilience, storage and computing, and they are usually linked to operational entities, such as coordination centers.

The middleware nodes can automatically choose to only synchronize the metadata and signaling to save some bandwidth, which could be referred to as a partial synchronization. The payload stays on other nodes and will be retrieved only on the request of a user. If the whole system is synchronized, it would be referred to as a complete synchronization. Further, the middleware nodes can select to transcode some payloads in order to reduce their size. For example, the middleware can reduce the resolution of a picture as the transfer bandwidth or latency is not appropriate.

The middleware nodes automatically discover the other nodes and which types of connections are around them. This permits the system to model the nodes' topology including their links. For example, FIG. 13 shows a topology example. In this figure, the nodes are spread along different communication networks marked as IAN 1304 (Incident Area Network) and WACN 1305 (Wide Area Crisis Network). The IAN represents the connection between mobile nodes 1302 deported on the crisis site whereas WACN represents the connection between central nodes 1301 and mobile nodes. The networks and nodes communicate via communication links 1303, which can be wireless or wired. The nodes are then self-adapting their configuration according to the detected topology. The same protocol permits user or client applications to auto-configure. A request for access to certain services will result in the address of the software entities able to provide them the services. Thus, the system allows for the filtering of the information to mark it as applicable to one or more disasters, crisis, or mission so the information can be assigned to a communication node.

In the present invention it is important to note the distinction to be made between the two kinds of middleware. There are some differences in roles and importance, including CC and MU among them. Also, any middleware is potentially authoritative for some data, including data from camera service, sensor service, event service, and/or map element service. For some services, it is desirable to maintain a unidirectional level: in this case, only the CC middleware 1301 are managing the data. The data is then not synchronized, but distributed to MUs. For example, Directory information that requires a complete integrity and the Map Tiles, which are generally distributed from the central platform, are types of information that follow this unidirectional model.

The synchronization process includes three steps: Distribution/Detection of service availability (distribution logic is provided by the Management Service); Negotiation, which is identical for the synchronizing of all services (e.g. Event, Camera, Map Elements, Sensor) and is provided by DISP middleware synchronization tools; and Synchronization, which is specific to each service.

As a first step of the synchronization processing, the available Middleware installations on the network need to get to know about each other. This availability, however, can change over time, for example due to changes in network connectivity, network capabilities, or network availability. The Management Service of the Middleware plays a special role here, since its main responsibility is to collect and distribute information about availability of Middleware services among the network, as fundamental basis of the synchronization.

A second step involves the Directory Service, which allows the definition of Missions. The Directory Service contains the general structures of the implied elements in the Missions, including the middleware, but also users, vehicles or maps. These structures can then define specific synchronization requirements, in that they define relationships between certain Middleware installations and the information they should get and synchronize. End users define missions dynamically, so these structural definitions can be modified over time to adapt to changing requirements of information exchange. The Directory Service can be considered as the general structure used as a basis by the other services of the middleware. Its synchronization is therefore a completely different mechanism: Directory Service data is always synchronized, the assumption being that Missions definition is always available to all middleware.

Finally, all further Middleware services make use of the previously mentioned information, to control their own synchronization according to defined rules relying on the mission definition or on simpler concepts. All Middleware services but the Management and Directory Service take the same basic approach for controlling and executing the synchronization processing, even though the details may differ to some extent for each type of service. The present concept introduces resilience: the information distribution will allow the middleware installations to cope with situations in which a Middleware, or part of it, fails to operate correctly, by providing back up or failover support.

The Middleware will manage end devices, such as sensors, maps and/or cameras. For example, it will retrieve the latest values from a sensor, pictures from camera or maps information provided by end-users or observation equipment. This functionality is not possible with a single, centralized Middleware during periods of network disconnection, effectively resulting in the potential loss of information. Mobile installations of the Middleware, which are close to the devices they manage, i.e., close in terms of network structure, and/or physically, reduce this problem and make this management more independent of the network connectivity towards a central network.

The Middleware is the main information resource for client applications, providing a unified view on available resources. Client applications can however be located close to the centralized network, which are usually Web Applications, or to a mobile network, which will usually be a Tactical or Mobile Applications, but can also be Web Applications. Applications specifically used within a mobile environment should be able to retrieve their information from a Middleware that is close to them, to improve efficiency, especially if there are multiple clients, and reduce the clients' dependence on network capabilities. Mobile client applications are still able to access to information from a “local” Middleware in case of network disconnections from the central network. So they can still access to reliable information of local resources, including e cameras and/or sensors, by this way, and have additionally access to all previously synchronized information from the local Middleware, without having to take own efforts for caching or synchronization.

FIG. 2 shows an example for a distributed network architecture, which involves five Middleware installations. The figure also shows the type and ID for each Middleware, and indicates the available networks and communication links between them. Two of the installations are Crisis Center (CC) Middleware installations 211, 212, which are part of a central network 200 and mainly provide load balancing and failover or backup capabilities, in contrast to using only a single CC installation.

The Middleware for two of the three Mobile Units (MU) 213, 214 is contained within a local network 201. This means that they are closely located to each other, and in addition to capabilities for communication with the central network 200, they participate in some mobile on-site network. This network allows for a direct communication between the Middleware installations over the mobile network 201, which typically provides a higher quality and bandwidth compared to the wide-range network connectivity to the central network 200. One other Mobile Unit Middleware installation 215 is shown in the diagram, which is also connected to the central network 200, but is not part of a mobile on-site network 201.

All of the MUs have a network connection to the central network 200, which is indicated by the communication links 221, 222, 223 from each MU to one of the CCs. Each of the MUs can connect to both CCs, although this detail is not illustrated in the figure, and each MU 213, 214, 215 will choose one of the available CCs 211, 212 to communicate with for synchronization. The example network shows all types of communication links that are used for the synchronization, which can shortly be summarized as follows:
CC-to-CC 224: These links are within the central network and as such can be assumed to have large capabilities, and very few disruptions of availability. Synchronization on this level can make use of the high network capacities, and does not need to take care about the consumed bandwidth etc. as much.
MU-to-CC 221, 222, 223: These links are potentially the weakest links, since they can involve different types of network communication, with varying bandwidth and quality properties. There can also be periods of unavailability for them, due to switching between different network types or general unavailability of any WAN network. Therefore, synchronization on this level should take special care to make especially efficient use of the network, and to only transmit information that is actually required.
MU-to-MU 220: These links are only available for MUs that are closely located to each other and have appropriate equipment to build a mobile network 201. If available, such network links are typically of a higher quality than the MU-to-CC links 221, 222, 223. They can generally not be assumed to be in place, but should be used to a maximum extent if they are in fact available. So synchronization on this level should be done in preference/priority to synchronization over MU-to-CC links.

Links between two MUs that are not part of a common mobile network 201 are also possible (from the network point of view), but not included in the list above because no (direct) synchronization of information is ever done using such links. Such connections need to pass a potentially “weak” network link twice (from one MU 221 to the central network 200, 224 and from there to the other MU 223). So instead of an MU directly communicating with another MU like this, the MU would first synchronize information with a CC Middleware. A second MU Middleware might then still receive updated information from the first MU, but only indirectly—by its own synchronization with the CC Middleware. This has two advantages:

1. Any synchronization operation between two Middleware installations makes use of at most one potentially weak MU-to-CC network link 221, 222, 223.
2. The approach automatically ensures to also provide updated information from the MUs to the central CC Middleware network 200. No further synchronization between MU and CC needs to be done in addition to achieve this.

This restriction is however only valid for the active synchronization processing which is done by any Middleware service, as described in this document. It does not mean that network connections between two MU Middleware installations (without a shared mobile network) are not possible or required in certain cases. End-to-end connectivity must be provided by the underlying network structure in any case, between any pair of Middleware installations, so that each Middleware node must in principal be capable of connecting to any other Middleware node, if the networks in between are available.

The Middleware synchronization achieves several basic requirements, namely information distribution, automatic discovery, utilization of the network structure, failure tolerance, as well as the synchronization. The primary goal and purpose of the synchronization is to allow distribution of information among a network of Middleware installations, for the different kinds of resources that are managed by the Middleware services. The synchronization requires communication between multiple Middleware installations. However, due to the different and changing networks involved, it can be difficult for the nodes in a Middleware network to get to know about each other. To minimize the required configuration effort, automatic discovery of the active Middleware installations is provided. This also implies detection of longer periods of network disconnection or unavailability in general. This requirement is especially important in the context of MUs, since they are the type of Middleware which may be unavailable for long times, and will perhaps only be started on demand.

The synchronization needs to make use of information about the current network structure. For example, this includes preferring higher-quality network links over others with fewer capabilities. Due to the variations in the capabilities of the network environment, specifically for MUs, network disconnections or situations of low-quality connectivity quality must be taken into account for the synchronization. Especially, any possible failure of synchronization operations needs to be dealt with, and must allow for a graceful and efficient recovery after regaining lost or interrupted connectivity.

A simple approach, which constantly attempts to synchronize all available information with all available Middleware installations, is insufficient for several reasons. The main problem with this approach is that it doesn't scale, since the processing time, bandwidth, and storage resources quickly increase with the number of Middleware nodes—and the resources especially for the MUs are limited in all of these dimensions. Because of this, restrictions need to be put in place as limitations according to some model. A dynamic model must be put into place that allows controlling what information needs to be transmitted (synchronized) to where. This will allow for a restricted synchronization, so it limits the amount of synchronized information. This is important to prevent distributing information to places or people that actually do not need to have them—which would otherwise be an unnecessary waste of resources, and would add additional security/privacy issues. Once again, this point is of most importance to any MU, since MUs as mobile units are subject to much greater security threats by nature, compared to a centralized CC Middleware.

The system of the present invention will allow for dynamic changes of the definitions about synchronization rules, depending on the situation changes in the context of usage of the Middleware network. Taking the example of multiple MUs that are installed, for example, in cars of emergency vehicles, it must be possible to define that some of them need to share information with each other, in case they are supposed to fulfill some kind of mission together. That configuration depends on the external context of usage of the Middleware and requires changes over time.

An important (albeit obvious) requirement for the synchronization is to be efficient, to make best use of the available (especially network) resources. This mainly means to exchange as little redundant information as possible. The primary purpose of synchronization is to distribute information about resources that are available, such as metadata, and if possible also the resources themselves, such as payload. The latter is not always possible however, because the payload can be very large and require a lot of resources, without actually being required by a user in the end. Furthermore, automatic ahead-of-time synchronization of the payload is generally not always possible. For example, the distribution of access information for a live video or picture can easily be done ahead of time—but the actual live picture or video stream cannot due to its nature. These kinds of payload are necessarily only transmitted as required (i.e. when a user explicitly requests to get access to them). So the synchronization must ensure to primarily distribute the metadata information, and only include the payload if possible and if it doesn't provide too much overhead. If required, corresponding payload can otherwise be loaded on demand—independent of the synchronization processing.

To aid the understanding of some of basic concepts the following terms are provided:
Middleware Type: One of CC or MU, which is a constant setting for any Middleware installation, and defines the role of the Middleware (Command Centre vs. Mobile Unit) in the architecture.
Middleware Id: A unique textual identifier for a Middleware, which is typically derived from the hostname of the machine on which it is installed. Typical examples for Middleware Ids are “pssu-srv01” or “pssu-pc01”.
MissionId is a unique identifier in a middleware in order to “group” the information managed by one middleware and linked to one Mission. The Mission is global (to the entire Middleware infrastructure) and defined in the Directory Service. The missionId is then composed by the name of the Mission and the name of the Middleware. Then, every data in the Middleware is marked as owned by one and only one authoritative middleware installation. Every missionId is globally unique, and can be represented with the String: missionName.middlewareId
   Every Middleware has at least one missionId (the “void” missionId). This technical missionId is used to store information that is not part of any mission. MissionIds are used as the basic units of synchronization within the Middleware.

Synchronization with respect to the Middleware services is achieved by exchanging information about mission models, so the distribution of such mission models (or updates for them) is the fundamental basis for the synchronization. Since every missionId belongs to (or is owned by) a certain middleware, there is always one specific authoritative Middleware for any missionId model. This allows for a relatively easy synchronization concept, since changes to the content of any missionId model are only done in the authoritative Middleware, and distributed (replicated) from there to other Middleware installations. Actual synchronization of missionId models happens also on a per-service level. This means that even though missionId are the basic unit of synchronization, this is actually true for each service separately. So for example, the Camera Service manages a model for a given missionId, the Sensor Service has a separate model for the same missionId. The information stored in the missionId models of different services are however disjoint, since every Middleware service deals with different kinds of information. The rules for controlling the exchange of missionId models are however the same for all Middleware services, so an abstraction can be made to talk about missionId models for whole Middleware installations (consisting of the merged information from all Middleware services for a certain missionId), for the sake of simplicity.

Also note that the Management Service of the Middleware is not involved in the approach described here. This service is responsible for the distribution of network/connectivity availability between Middleware installations, and as such is not directly involved in the actual distribution of application-layer information (even though it provides a basis to allowing this).

The different Middleware types have different roles in the overall architecture. The CC Middleware installations will receive all available information from the whole Middleware network, i.e., information of all possible missionId, since they are the central places of the architecture and supposed to have a global view on all information. If multiple CCs are present, they will ensure to have the same information available, by synchronization with each other. A main consequence of this claim is that from the point of view of an MU, each of the available CCs should act in the same way, so the CCs can actually be considered as a kind of CC “cluster”. Thus, an MU can then communicate with any of the available CCs for synchronization, which is useful for load balancing and failover capabilities. The MU Middleware installations will, by default, only be interested in the information related to the missions it is allowed to get. What information should be available to which middleware is defined in the Directory Service. Middleware can potentially collect data for any missions, in order to allow device roaming. For example, a device wanting to save some data for mission2, but the only Middleware available is MU01, then the device will save its data on MU01, and the missionId mission2.MU01 will be created (if not existing yet) on MU01. MU01 is still unable to get data related to mission2 from other middleware installations; but can propose the missionId mission2.MU01 to other middleware. The definitions specify what information on the basis of missionIds each Middleware is principally interested in. They however don't explain yet how they actually get hold of updated information from one another.

The actual synchronization processing allows the exchange of missionId information, to achieve two synchronization goals, namely providing all information to CCs and providing information to MUs according to Mission definitions. Providing all information to CCs is achieved by making sure that multiple CCs (if present) are always synchronizing all information they have with each other, independent of any mission membership (CC-to-CC 224), and each MU Middleware always tries to provide all updated information it may have to any of the available CCs (MU-to-CC 221, 222, 223). This basic synchronization needs to always be executed, independent of any mission definition. This ensures that the CCs always have the maximum of information available, and that they are properly synchronized among each other. The synchronization among multiple CCs is important to allow the MUs to synchronize with any of the available CCs by providing failover and load balancing.

The basic synchronization however does not take care yet of providing any information towards an MU. That's where the mission membership concept comes into play. The mission definitions specify what information on a per-mission level an MU Middleware is supposed to receive through synchronization. If no mission exists which “contains” or “is allocated to” the given MU Middleware, then this Middleware should not retrieve any information about other related missionIds through synchronization.

Achieving the goal of providing information to MUs according to Mission definitions is achieved by ensuring that any MU Middleware is always held up-to-date with the latest information about the definition of missions it might be part of (Directory Service data must be correctly distributed) and an MU Middleware which is part of one or more mission(s) adapts its synchronization logic to also synchronize with other MUs in the mobile network 201, if the MU is in fact part of a mobile network with other MUs, and if there is information to be shared with them according to the mission definition (MU-to-MU 220). This is done in a first step of the synchronization processing, to put priority on distributing updated information among the nodes within a mobile network 201, before making use of potentially weak MU-to-CC network links 221, 222, 223 in the second step. As well as synchronize with any of the available CCs 211, 212 in a second step.

The distribution of missionId models needs to be triggered to start the processing, which is done by a periodic initiation of the synchronization processing, in a certain interval. This approach however produces delays for updated information about a missionId to be distributed with other Middleware installations (even in situations of optimal connectivity), according to the chosen interval of triggering. Also, this approach results in triggering communication between Middleware installations, even though there may not actually be any updates of missionId models to be exchanged between them. This introduces communication overhead in the approach. This overhead will be larger with smaller intervals of synchronization triggering. The interval can however not be chosen too large, to still have an acceptable delays in information synchronization. So a trade-off has to be made. For specific case (or specific missions) the period of synchronization can be adapted to provide more interactivity at higher cost in the communication overhead.

The approach in the Middleware is the interval in which the synchronization processing is triggered is rather small (typically once per minute), to reduce the synchronization delays to deal with. The synchronization processing uses a first step of change detection (the negotiation step), which can be executed quickly and only requires exchange of a small amount of information. This allows minimizing the communication overhead, since the synchronization processing can quickly be aborted if the first step detects that in fact no information needs to be exchanged. The periodic synchronization triggering is done within the different Middleware services, for both CC and MU Middleware installations. The way of processing is however different depending on the Middleware type. When synchronization is triggered within a CC Middleware service, it will only try to synchronize information with other CC Middleware services (CC-to-CC 224). This ensures keeping the CCs synchronized, but doesn't imply communication with MUs at all. So the CCs don't need to actively take care about availability status of the MU services. When synchronization is triggered within an MU Middleware service, it will first try to synchronize with other MUs in a mobile network 201 if available (MU-to-MU 220). Afterwards, it tries to synchronize with any of the available CCs in a seconds step (MU-to-CC 221, 222, 223) to provide updated information to the central network, and retrieve updates from the central network if necessary.

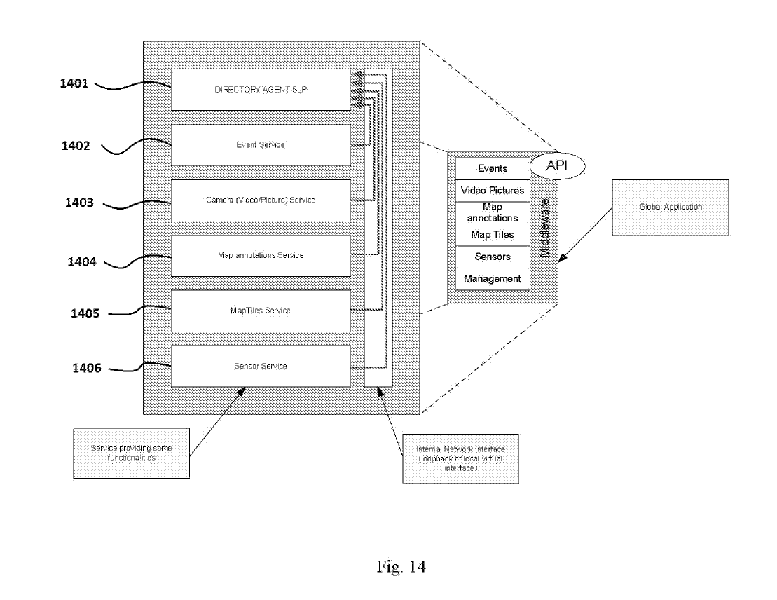

The different Middleware installations don't contain any configuration about the location of other installations, so by default they don't know which other Middleware is available. Hence, a basic precondition for synchronization of application-layer information is to first get to know about other Middleware (services) to potentially synchronize with. This is realized by the Management Service, which is contained in any Middleware installation. The main goal of the Management Service is to collect and distribute availability information about the Middleware network, according to specific rules. Note however that such availability information is not only defined for the Middleware as a whole, but rather on basis of the Middleware components (services). Every Middleware service, except for the Management Service itself, e.g., Event Service 1402, Camera Service 1403, Sensor Service 1406, takes care of registering with the Management Service on the same Middleware installation, to indicate its own availability, as shown in FIG. 14. These registrations need to be refreshed periodically, since they have a limited lifetime. By this way, the Management Service is always informed about the current status of the local Middleware it belongs to.

In addition, the Management Service distributes the information about the local Middleware status among the network, using Multicast messages. On the other end, the Management Service also receives such messages from the Management Services of other Middleware installations on the network, and can build and keep a registry of the overall available Middleware services from them. Due to the expiration time of registrations, the registry is not guaranteed to always be accurate, but it ensures to adapt to new situations after a certain time, which depends on the lifetime of registrations, usually about one minute. By this way, the Management Service is always supposed to be up-to-date regarding the status of the local Middleware installation, and its services, to which the Management Service belongs and the status of other Middleware installations, and their services, available on the network. On top of this, in order to limit the way in which this service availability information is actually distributed within a network of Middleware installations, certain rules are deployed. The differentiation between Middleware types (CC vs. MU) plays a major role for this. To aid the understanding of some of basic concepts the following terms are provided:
Central network 200 is the network that interconnect the CC together and the connections to the MUs.
Local network 201 is the network that interconnects the MUs together.

The goals of the availability distribution are as follows:

1. CCs should get to know about all other available CCs, since they need to take care to be fully synchronized among each other. This information is required for CC-to-CC communication 224.
2. CCs should only get to know about MUs that are “directly” connected to the central network. There may also be MUs that don't have an own direct connection to the central network, but can still use an indirect connection over a mobile network to be able to connect to resources of the central network. Such MUs should practically be invisible from the CCs, so availability information of them must not be available on the CCs.
3. MUs should retrieve information about all available CCs in the central network 200. If multiple CCs are available, they can choose any of them to synchronize with. This information is required for MU-to-CC communication 221, 222, 223.
4. MUs should get to know about other MUs if and only if they are participants of a local network 201, over which they can “directly” communicate with each other. It is crucial to ensure that MUs may never get to other MUs if this pre-condition is not given. So Middleware services in an MU that retrieve availability information of other MUs, need to be able to rely on the assumption that those two MUs are part of a mobile network. This information is required for MU-to-MU communication 220.

To achieve these goals, the Management Service uses different message types (scopes) and multiple multicast groups to distribute the service availability information among the network.

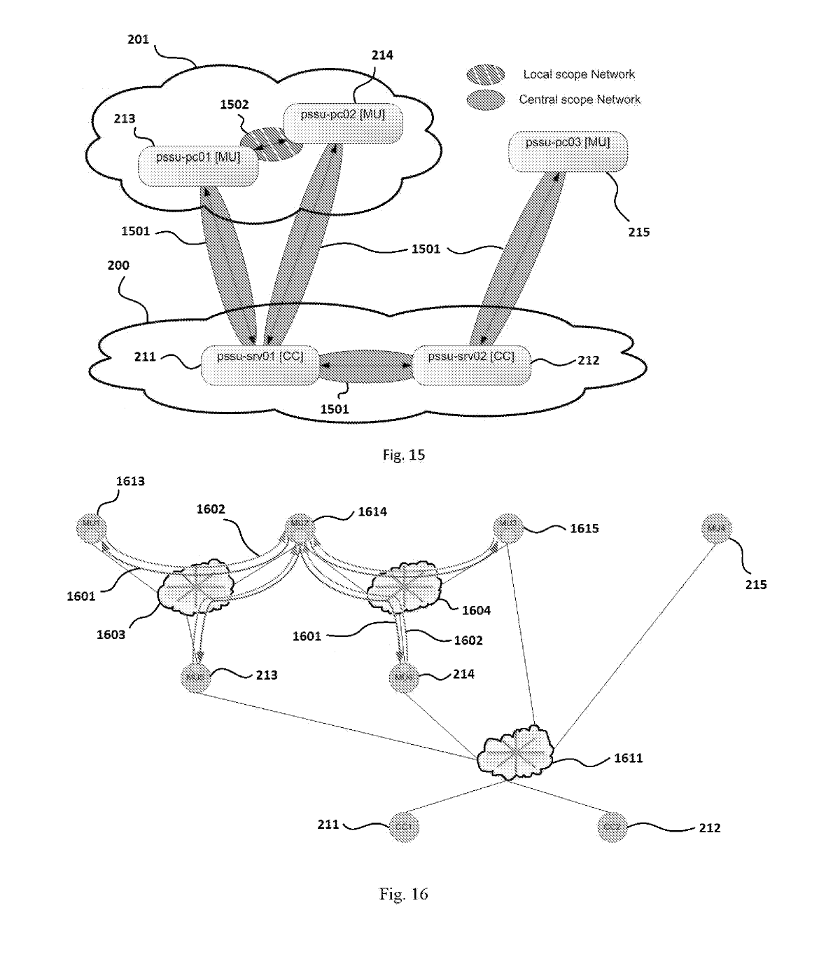

The present invention uses a multicast scoping concept. First, two different multicast groups are used in two different scopes, as seen in FIG. 15. The scope concept permits to block the sending of multicast messages to a specific area.
The central scope 1501 permits to send registration messages and request messages on the central part of the networks. All middleware installations, both CC 211, 212 and MU 213, 214, 215, are sending registration messages in this scope. The scope is actually available for CC middleware and for MU middleware connected via WAN connections.
The local scope 1502 permits to send registration messages and request messages at the local level of the network. Only MU middleware 213, 214 connected to a local network 201 can send message in this scope.

The middleware can send and receive message from the different scopes. The middleware can then detect the other middleware installations, their type and from which type of connection it is visible (local 201 and central 200). The messages sent to the different scopes also include the different service available in the middleware installation.

At this point, the Management Service builds up a registry about the available Middleware services of other (remote) Middleware installations, based on the received registration messages and according to the restrictions described above. In FIG. 16, the process of discovery is shown via a schematic diagram showing the multicast flows using SLP (Service Location Protocol) messages 1601, 1602 in order to register the services between middleware. The nodes are sending different part of the SLP protocol primitives (register, request or search) over a multicast transport network. The middleware nodes are represented as the circles 211, 212, 213, 214, 215, 1613, 1614, 1615 and arrows 1601, 1602 represent the protocol exchange between the nodes. The protocol is based on the SLP (Service Location Protocol). This protocol is here used within multicast transport to request 1601 (search) for a service and the reachable nodes are answering 1602 if the service is available with access parameters. In this figure the star in the cloud 1603, 1604, 1611 represents two detached communication networks. Each of the records in the registry describes the availability of one specific service, within a specific Middleware installation. The record, which is also required for the higher-level synchronization, consists of the following:
The ID of the Middleware to which the service belongs
The type of the Middleware to which the service belongs (CC/MU)
The scope used to discover this middleware installation
The service type using a common identifier, like SensorSry or DirectorySry
The service version which can be the currently unused implementation detail
The URL that must be used for connecting to this service. This will however only contain a base URL, which will need to be completed according the interface of a service to connect to.
The remaining lifetime of the record, which is defined by an expiration time

The Management Service furthermore provides a simple local interface for all other services of the same Middleware, allowing them to access to information from the registry. The services make use of this interface to stay up-to-date with availability of remote service instances, for example, those of the same type, e.g. the Camera Service only retrieves information about other remote instances of the Camera Service, etc. Such remote service instances can then be considered possible candidates to synchronize with, and are used as basis for the further synchronization logic.

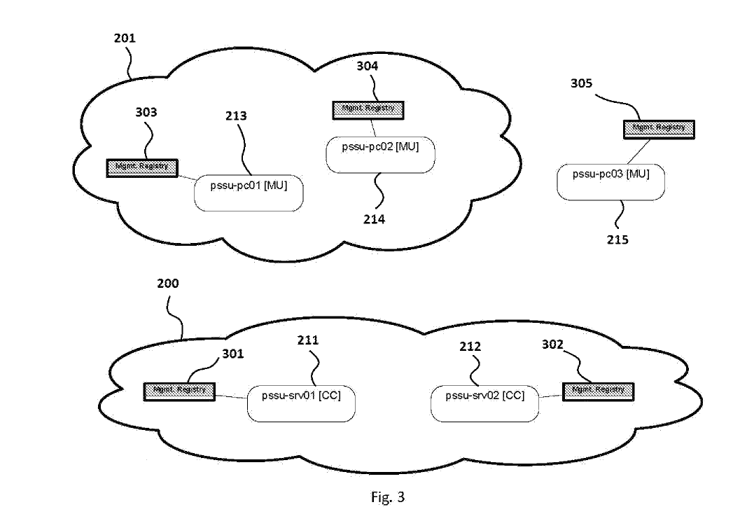

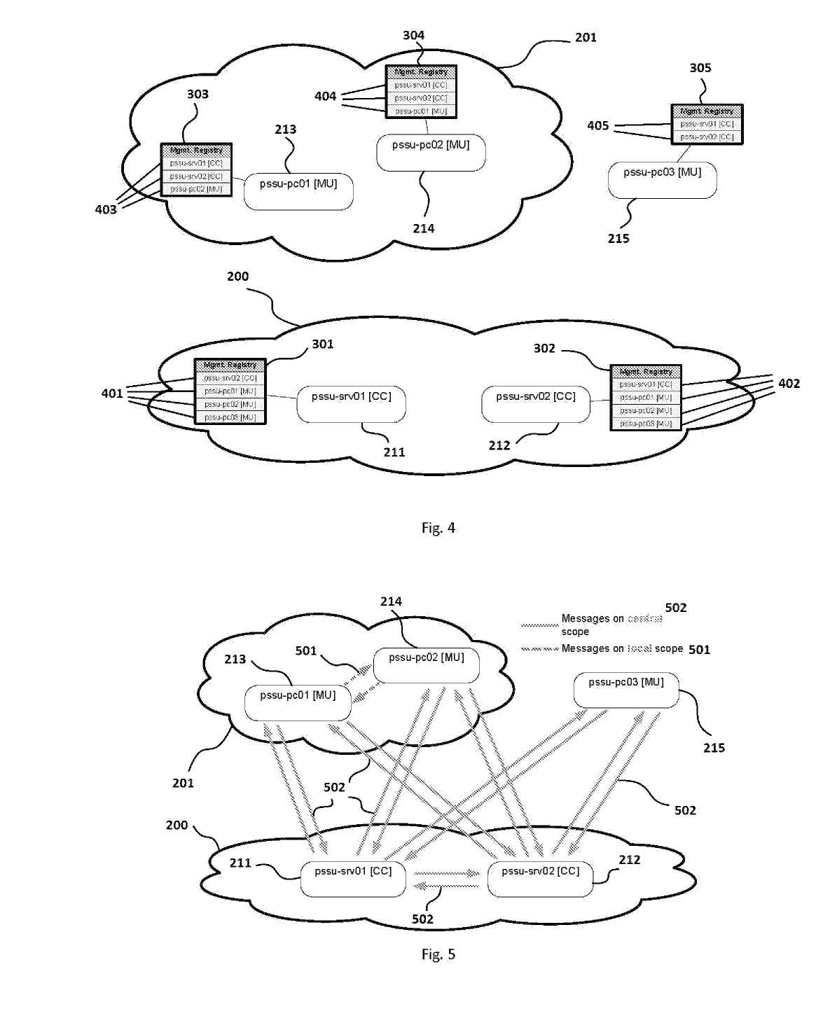

FIGS. 3 and 4 illustrate how the Management Service registry would look like in an example network. For the purpose of this example, only a single record is shown for each Middleware, instead of each Middleware service, and only the most important properties for each record are displayed to illustrate the concept, although more could be involved. FIG. 3 shows the initial Middleware network, without any information distributed by the Management Service yet. FIG. 3 indicates the status of the Management registry 301, 302, 303, 304, 305 for each Middleware 211, 212, 213, 214, 215, which is empty. After the different instances of the Management Service advertised the presence of their own Middleware on the network, the different service instances now know about the availability of other Middleware installations, according to the rules defined above. This situation is shown in FIG. 4, in which the registries 310, 302, 303, 304, 305 of the Management Service are filled with the appropriate records 401, 402, 403, 404, 405 of remote Middleware installations:

Building the content of these registries will happen in multiple steps, but FIG. 5 shows the final result—assuming that all network links are available. As illustrated in FIG. 5, the CCs 211, 212 get to know about each other and the CCs get to know about the available MUs 213, 214, 215 directly connected to a central network 200. Also, the MUs get to know about all CCs, and finally, the MUs 213, 214 only get to know about each other, if they are part of a common mobile network 201. FIG. 5 illustrates the final state once again, by showing the possible communication links for synchronization that arise from this information in the Management Service.

Apart from the internal middleware flows, the same concept of auto-discovery is applied to configure the clients of the middleware. Using the same multicast groups, a software client can look for available services present in middleware nodes by sending “Service Request” messages similarly to the registration messages sent by the middleware services and middleware. The client can send the Service Requests messages using the local scope 501 first (in order to find local middleware nodes) and extend it to the central scope 502 if it does not receive any response using the local scope. This will provide similarly auto-configuration for the clients based on the same concept that the middleware nodes. Finally, the clients are searching for services and can then get multiple answers on different middleware. This is ensuring a better resilience as several similar source of information will be identified.

Based on this auto-discovered topology and following the synchronization rules, each service of the middleware can be synchronized with the adequate information. The synchronization is triggered periodically for each service instance, typically once per minute. The further steps that have to be taken for execution of the synchronization depend on the Middleware type and information about the environment.

The synchronization processing starts out with a choice of other service instances to initiate the synchronization process with. For each of these partners, the synchronization process is then executed in multiple steps, starting with the missionId status negotiation and followed by exchange of missionId diff structures for updating the missionId models on either side as necessary. Some details are given to explain the data structures used to stored and exchange information in an efficient way. The last section finally explains some further details, which are not essential to understand the general synchronization processing, but important for overall consistency.

FIG. 6 shows another example of a Middleware network, which illustrates the effects of the synchronization processing. The figure specifically shows the missionId models that are stored within the Middleware for any of the service in the middleware. The initial status displayed here only shows the own missionId for each Middleware, i.e. those for which the Middleware installations are the authority. This means that no synchronization happened yet, and there are no synchronized missionId models in the network.

Once the synchronization is triggered for a Middleware service, the first step is choosing which other service instances will be synchronize with. This includes the type of Middleware the service is part of (CC/MU) and other service instances that are available to potentially synchronize with, as retrieved from the Management Service of the Middleware. The logic for choosing depends on the Middleware type. Since a service in a CC Middleware should only synchronize with services in other CC Middleware installations (CC-to-CC 224), the service will analyze the information from the Management Service about currently available remote service instances (of the same type), and extract all other CC service instances that are available. The further synchronization logic will then be executed for all of these remote CC service instances, with an attempt to fully synchronize with each of them.

Since a service in an MU Middleware should synchronize with other MU services in a mobile network, and additionally with one of the available CC services, the service will analyze the information from the Management Service about currently available remote service instances, which are of the same type, and separately extract all other local MU service instances and all CC service instances that are available. The further synchronization logic will then first be executed for all of the retrieved MU service instances, to distribute relevant information within a mobile network (MU-to-MU 220). This step however depends on the current Mission definition, which is retrieved from the local Directory Service. Synchronization with another local MU service is in fact only executed if there is currently a Mission configured so at least one of the MUs' has access to a missionId data and has an outdated timestamp for the given missionId.

In a second step, the synchronization logic will then also be executed for any of the available CC service instances (MU-to-CC 221, 222, 223). It is sufficient to only synchronize with any of the CCs 211, 212, because all CCs are supposed to synchronize among each other. The MU randomly chooses one of the available CCs, effectively resulting in an application-level load balancing for the MU-to-CC synchronization. If the synchronization however fails for any reason, the MU can still attempt to try synchronization with one of the other CCs. To execute the synchronization, the MU will generally provide all updated information it may have about its own and other missionIds to the CC, but it will only try to receive updates from the CC about missionIds to which it is related by mission it is part of.

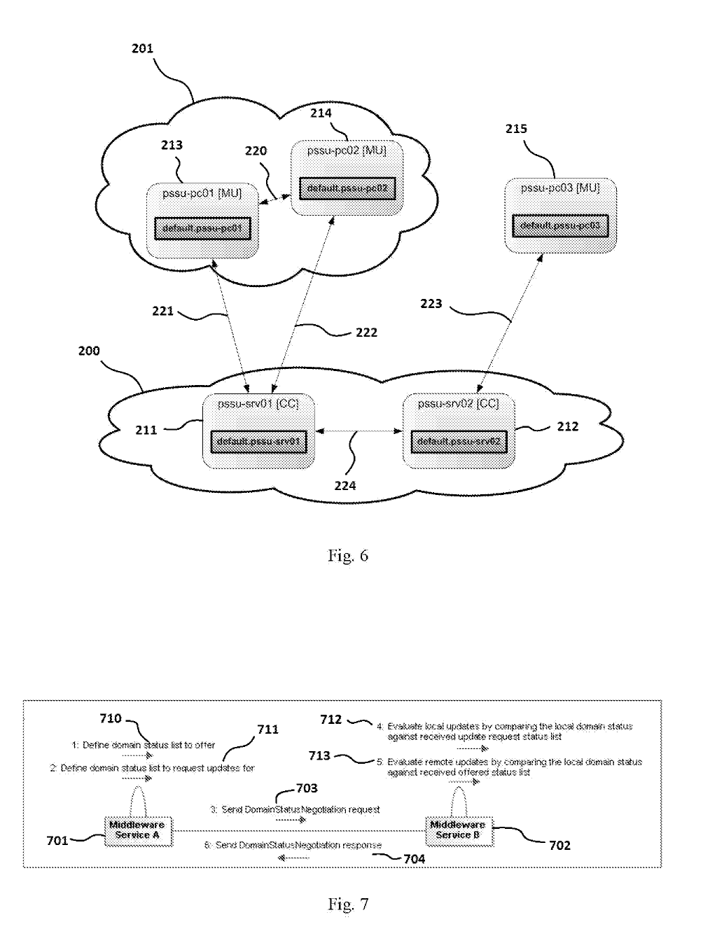

The missionId status negotiation is the first actual step of communication to realize the synchronization between two service instances. It can be executed quickly to minimize the general overhead of the synchronization and is done in exactly the same way for all of the Middleware services. The negotiation is generally triggered by one of the services (service A 701, FIG. 7), by sending a negotiation request 703 to another service instance of the same type (service B 702), which answers with a negotiation response 704. This information exchange is sufficient to determine which missionId models afterwards have to be updated on service A 701 or B 702, respectively. The negotiation request sent by service A 701 contains the Id and type of the Middleware which service A is part of, as well as a list of missionId status records with descriptions of the missionId models that are offered by service A 701 to service B 702 (offered missionIds). Each of the missionId status records is a simple structure which contains a missionId and a modification timestamp for that missionId, which defines the status or version of the missionId model that service A 701 currently has 710. This modification timestamp may also be undefined (null) in certain conditions, for example if service A is interested in a certain missionId model but doesn't have any information about it yet.

The negotiation response created by service B 702 is built by comparing 712, 713 the information from the request and the current own missionId models stored in the database with each other. This allows service B 702 to quickly check if it has any updates compared to the missions allowed for the service A 701. The negotiation response 704 sent by service B 702 actually has a very similar structure than the request, and contains the Id and type of the Middleware which service B is part of a list of missionId status records with descriptions of the missionId models for which service A should require the actual synchronization (missionsToSync) and a list of missionId status records with descriptions of the missionId models for which service B can actually offer a valid update for (offered missionIds). This list has a slightly different purpose compared to the offered missionIds in the request. We don't need this information to offer updates to service A, since missionsToSync is sufficient for that purpose, but to allow service A 701 to determine which updates it has to push to service B 702 (service A is the initiator of synchronization from A to B AND from B to A).

The records contained in the negotiation response afterwards define what further steps service A needs to take to make sure the necessary updates of the missionId models are exchanged from A to B and B to A, respectively.

Thus, both service A which initiates the communication, and service B which responds to the request are able to control which information they are actually interested in, and which information they are willing to share with another service (based on domain models). Also, the amount of exchanged information in this step is very small, since it only consists of simple records with missionIds and timestamps to describe missionIds status. If the response should indicate that neither side actually has updated information to retrieve from the other side, the synchronization between the two service instances is finished.

FIG. 7 provides a high-level summary of this process showing the difference between CC and MU about synchronization (CC eagerly get all data, MU only gets what it is allowed to get) is that basically, we ask the Directory which missions are allowed for a given MW. For a CC, ALL missions PLUS void are allowed, whereas for a MU, only the missions the MW is part of what are returned.

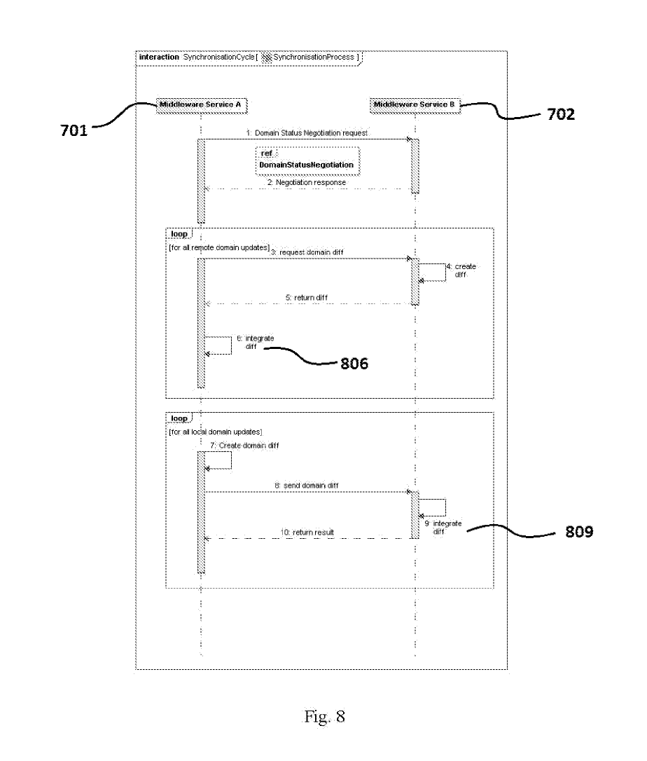

The result of the missionId status negotiation phase described above determines for which missionIds information needs to be exchanged between two Middleware service instances. After service A 701 received the negotiation response from service B 702, it uses the information in the response to finish the synchronization processing, by making sure that the necessary missionId models are actually exchanged in the second phase. This phase may be unnecessary if the negotiation response 704 did not contain any records for offered missionIds or the service is not allowed to get any missionId. For all missions to sync in the response of the negotiation phase, service A 701 will request a missionId update 703 from service B 702. It provides a missionId status description 710 as parameter to this request for service B, which again contains the missionId and timestamp to create an update for 711. Service B 702 creates and returns the missionId update, and service A 701 then integrates 806 (see FIG. 8) the update into the own database, to update the model of the missionId in question to the new version.

From the middleware Id in the response of the negotiation phase, service A will get the list of allowed missions for service B 702 (from its Directory Service) and create the corresponding missionId updates, and send them to service B 702. Service B then integrates 809 the update into the own database, to update the model of the missionIds in question to the new version.

FIG. 8 gives an abstract overview about this whole process. The efficiency of creation and integration of missionId updates, as well as the size of transmitted missionId updates is crucial for the overall performance of synchronization. Typically, a change in a missionId model only affects a small part of the overall information linked to that missionId. So, it should be possible to only transmit the changes that are necessary to allow updating an old missionId model into a more recent version, to limit the bandwidth and processing time. Using this approach however requires taking special care to ensure the overall quality of the missionId models does not suffer by the synchronization, i.e. to guarantee consistency.

The missionId models are actually stored for the Middleware services, and the structure of exchanged missionId updates (called missionId “diffs”) are allowed to transition between missionId versions looks like. The general idea and approach used for exchanging missionId update are provided, but only a simplified example view is given on these structures here, since they are actually different for each Middleware service.

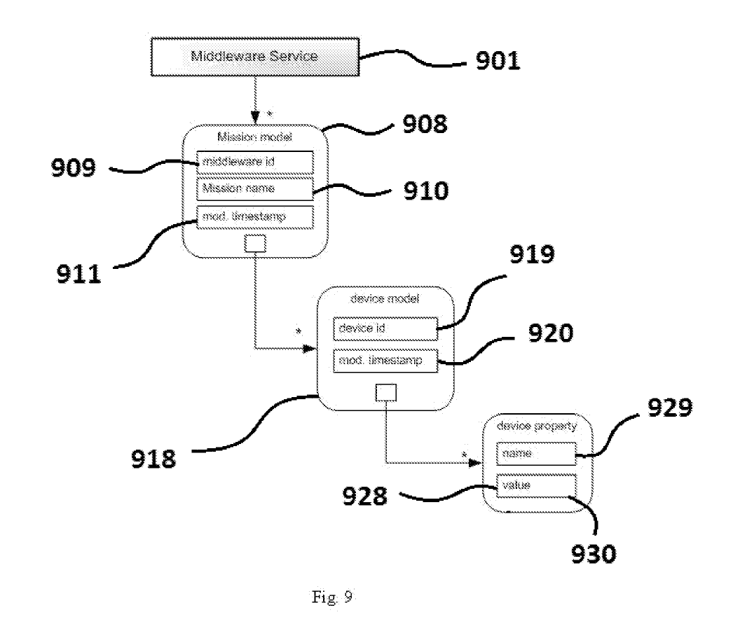

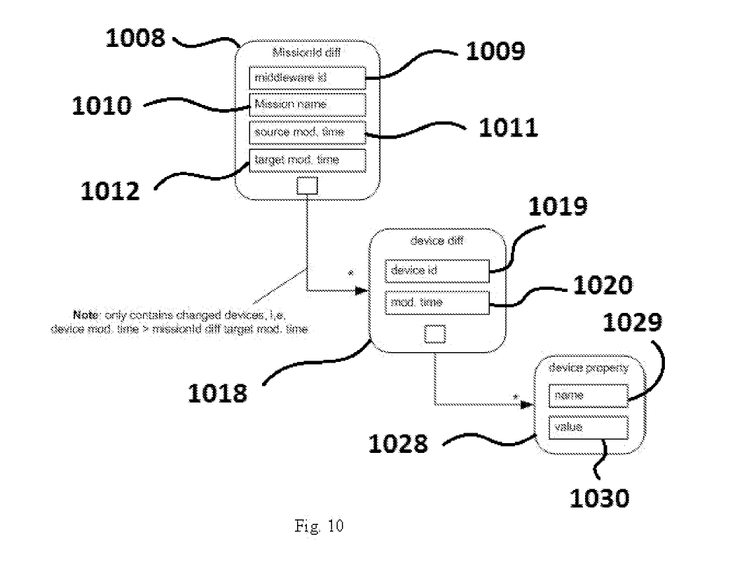

FIGS. 9 and 10 show a schematic example for a possible simple storage structure of a Middleware service 901. The actual storage structures of the services may differ for each service, so this figure only illustrates the general concept. Each service instance can store representations of multiple missionId models in its database. This will generally include at least one model for the own missionId(s), and additional missionId models received through the synchronization process from other service instances. Each missionId model is identified by a mission name 910 and a middleware id 909. Any missionId model also carries a modification timestamp 911, which is essential to specify the version of the represented model. This timestamp allows for a very quick-change detection, to determine if two missionId models (for the same missionId) differ, and if so which of them is more up-to-date than the other. Each missionId model contains a number of items that make up the actual content of the missionId model. In the figure, “device” items are used for this purpose (but only as a simple example). These device structures are identified by an id 919, and they also carry a modification timestamp 920, which can be compared to the modification timestamp 911 of the missionId model it belongs to, and this is important for synchronization. In addition, every device in this example contains a number of properties 928, which are defined by a list of name 929/value 930 properties.

These properties considered as part of the main content for describing a device in the example illustrated in FIGS. 9 and 10, and are important for consistent missionId model storage, especially in context of the synchronization approach. These include the changes to the properties of a device (adding, removing, or modifying a property for a device) may only be done by the service which is the authority for the missionId in which it is contained. This prevents any concurrent and conflicting modifications to a missionId model 908. Other service instances may only get to know about such changes through the synchronization processing. Any change to the properties 928 of a device must be accompanied by an update of the modification timestamp 920 of the device, and also by an update of the modification timestamp 911 of the missionId to which they belong. The update of the missionId timestamp 911 is especially important for synchronization, because this allows using the timestamp as missionId version—so it needs to always be increased whenever any content of the missionId model is modified. Other service instances can then simply consider the timestamps as an ordered version number, without necessarily having to interpret them as actual time. This has a further advantage of not requiring synchronized clocks on the different Middleware installations for the synchronization. Updates to a missionId model must happen in a transactional way. This is of particular importance to ensure that the updates of the modification timestamps 911 and updates of the missionId content happen in an automatic fashion, since the creation of consistent missionId diff 1008 models explained later on depends on this.

The purpose of a missionId diff structure is to describe the changes between two versions of a given missionId model. This description should be as efficient as possible, while still allowing for a consistent transformation of an “old” version of the missionId model into an updated one. FIG. 10 shows a schematic example for a possible structure of a missionId diff 1008, which is related to the missionId structure as described above and would allow transformation of such missionId models into updated versions. Since a missionId diff is always related to one specific missionId, it contains information about the missionId it belongs to (defined by the mission name 1010 and middleware ID 1009). Additionally, any missionId diff 1008 contains a source 1011 and a target 1012 modification time to describe the time range it was created for. Each missionId diff structure only allows a consistent transition from a missionId model to the target modification time 1012, if the old missionId model on which the diff is applied also carries exactly the source modification time of that diff as well. A missionId diff can be built to describe any time range, and the actual time range to use generally depends on the available versions of the missionId for the communication partners.

The source modification of a diff may be undefined (null), which is required to create an “initial” missionId diff for a service instance that doesn't have any information about that missionId yet. In this case, the missionId diff 1008 basically contains the full content of the missionId, and has a maximum size. The actual content of the diff is described in the same way as in the missionId model, by a number of device structures that are contained in the diff and their properties. The main difference to note here is however that a missionId diff does not need to contain all device structures that the missionId model 908 with version of the target modification timestamp 1012 contains. Instead, the diff only needs to include those devices that have changed in the time range of the diff (i.e. between the source time up to and including the target time).

The storage structure of the missionId models allow for an easy decision about this, simply by checking if the device modification time 1020 is smaller or equal to the source modification time 1011 of the missionId diff to be created. In this case, the device definition did not change in the time range of the missionId diff description and can be omitted. So this approach allows creating efficient missionId diff structures, which mainly need to contain information about structures that actually changed in the time range of the diff, and need therefore be included for a consistent missionId model update. However that this is only a simple example and could still be made more efficient—it is only used to illustrate the concept. Also, the actual structures used in the different Middleware services are more complex than this one. Further, this missionId diff description is actually not fully complete. The reason is that this structure is not capable of informing a receiver of a missionId diff about “removed” devices. If a given device was part of the missionId model at the source time, but has been deleted from the model afterwards, the service that creates the missionId diff will not know the device anymore, and hence it can't include a description of the removed device into the diff.

One solution for this problem, which is used in several actual Middleware services, is to extend the missionId diff description, to additionally includes the Ids of all devices into the diff that have not changed in the time range of the missionId diff. A receiver of a missionId diff can then execute a comparison of all devices in its old model against those in the diff and detect deleted devices as well. Unfortunately, this comes at the cost of having to include partially redundant information into the missionId diff again—but the list of device properties 1028 for such unchanged devices do not need to be included. So there is still a substantial reduction in the overall amount of information that has to be placed into a missionId diff 1008, compared to a full missionId model 908.

A Middleware service 901 that received a missionId diff 1008 can use it to transform the own model of that missionId into an updated version. For this to be possible however, the modification timestamp of its own (old) missionId model 908 needs to be equal to the source modification timestamp 1011 given in the missionId diff 1008. Also, the update of an old missionId model with an appropriate missionId diff is generally executed in a transactional way, to make sure the updated missionId model still ensures consistency.

The update transformation functionality could basically be described as follows, for updating a missionId model of missionId m at time t_1 to an updated version at time t_2:

update(model(m,t_{—}1),diff(m,t_{—}1,t_{—}2))=>model(m,t_{—}2)

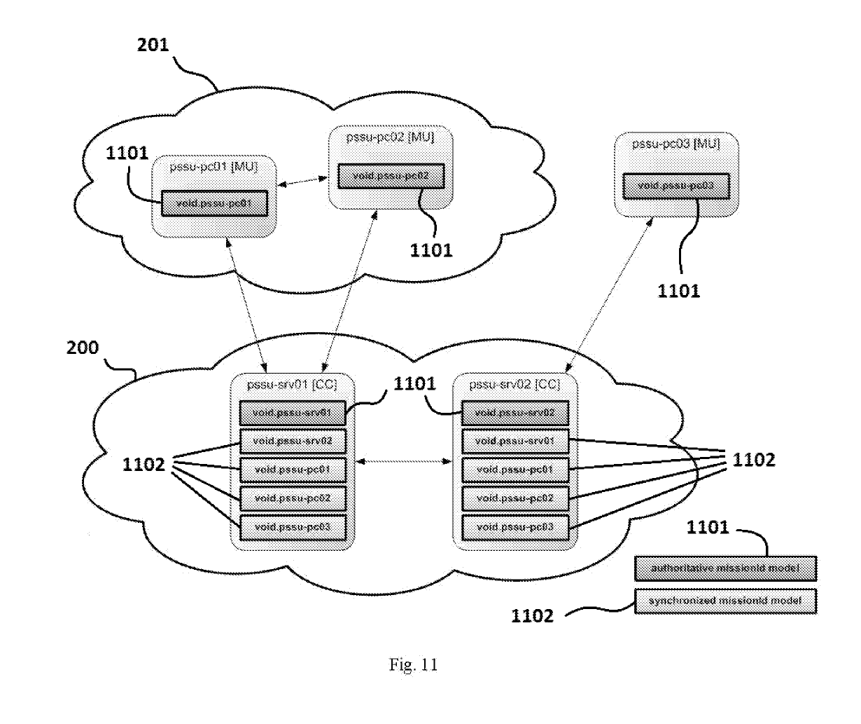

FIG. 11 shows how the example Middleware network would look like after all synchronization has been completed. The figure includes several simplifications, for example since it doesn't show the missionIds on the basis of the different Middleware services but rather for a Middleware as a whole. The diagram also does not show the versions, e.g., the timestamps, for the missionId models—the versions for each missionId are assumed to be the same here. If any of the authoritative missionId models 1101 would be updated in this example, its timestamp would change. This in turn causes further synchronization to be done, to take care of updating all synchronized models 1102 of that domain accordingly, as described above.

FIG. 11 reflects the status of the basic synchronization, i.e. in case there is no Task Force defined that has an additional effect. In this case, the MU Middleware nodes don't receive any synchronized information, but only provide information about their own domain models to the CCs. In addition, the CCs are taking care of synchronizing among each other, so each of them has the same information available.

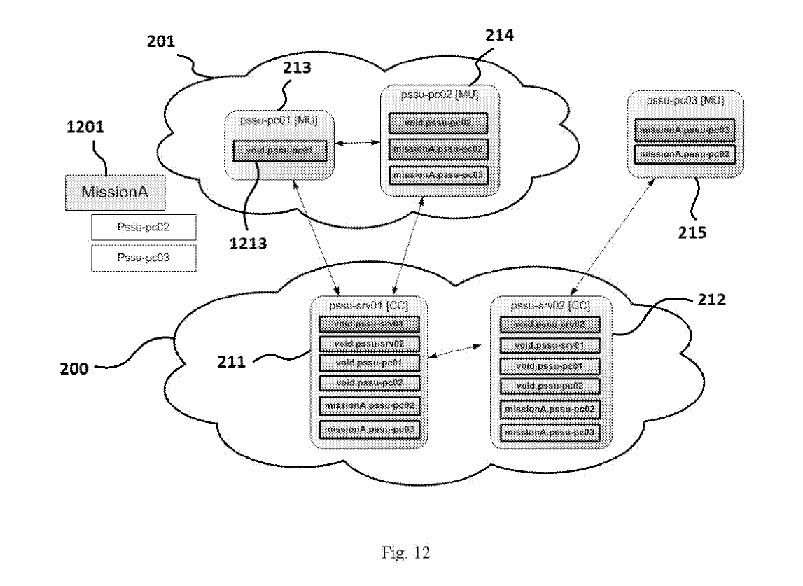

FIG. 12 shows the result of another scenario in which 2 middleware have accesses to the mission missionA 1201. After the synchronization, the 2 CC servers 211, 212 got all the missionId models, and each MU 213, 214, 215 got the missionId models it had access to. The order in which the synchronization processing is triggered between the different Middleware installations is not of importance for the final result. It does however influence the intermediate steps, i.e. the detailed way how to achieve the final state shown in the diagram.

Comparison FIG. 11 and FIG. 12 shows that Middleware pssu-pc01 1213 is not affected by the definition of the Task Force, since it has no access to the mission data. Furthermore, it can be seen that this “extended” synchronization subsumes the basic synchronization shown before, since the CCs still retrieve information about all missionIds that are available on the network as before.

There are some more details related to and important for synchronization. This mainly affects some additional processing in each service which is done for purposes of cleanup. This has been left out in the previous sections, to prevent them from becoming overly complicated. For completeness, the following list summarizes this additional processing:

Typically, the modification time of a missionId is only changed when some actual information has changed which belongs to the missionId. As one exception to this rule however, a service will also update that modification time for all local missionId (i.e. the missionId it owns) whenever the service is started, and then periodically in a large interval—by default, every 12 hours. This modification is done independent of any actual change in the content of the missionId, and is internally called missionId touch operation. This missionId touch operation ensures that—with a proper synchronization in place—any synchronized missionId model will always get an updated missionId timestamp at least about every 12 hours independent of actual changes. If this condition does not hold, this indicates a problem in synchronization—which typically means that the service to which the missionId model belongs is not running anymore or disconnected from a common network for a long time. These definitions are in fact used to allow for a cleanup operation specifically on synchronized missionId. This is achieved by checking the synchronized missionId models every now and then for their current modification time, and completely deleting a synchronized missionId model which carries a very old modification time—by default, the limit is one full day. Additionally, a service will not accept updates for a synchronized missionId which carries such an old timestamp anymore, to further prevent possible propagation of outdated synchronized missionId models in circles.

The logic assumes synchronized clocks for the services in different Middleware installations to some extent—however, the requirement is actually very lenient, since problems can only occur if the clocks are off for at least about 12 hours. This ensures that outdated synchronized information will eventually be erased, in case the missionId information cannot be considered accurate or up-to-date anymore due to a long unavailability of its authoritative source (either because no network connection is available, or because the Middleware has been shut down or removed). In addition, synchronized missionId models may also be fully removed by a service instance, if the service detects that it is not anymore “interested” in that missionId. This situation can happen within an MU Middleware, which used to have a Mission-based relationship with the missionId that no longer exists.

Although the invention has been described in detail with reference to particular examples and embodiments, the examples and embodiments contained herein are merely illustrative and are not an exhaustive list. Variations and modifications of the present invention will readily occur to those skilled in the art. The present invention includes all such modifications and equivalents. The claims alone are intended to set forth the limits of the present invention.

What is claimed is:

1. A computer network implemented system for monitoring and managing emergency service resources and for disaster and crisis management comprising:
a) at least one server computer having a computer readable medium, the server computer including an information collection utility that enables the computer to collect and store to a database linked to the server computer one or more information objects;
b) means for collecting and marking information related to a disaster or crisis;
c) at least one communications device configured to establish a network corresponding to that communications device;
d) a plurality of communication nodes, each node being connected to the network established by the communications device;
e) at least one fixed installation node adapted to model and manage the information collected, connected to said communications device, and capable of functioning as a crisis center;
f) a user application comprising software loaded in the computer readable medium at the computing device for execution by a processor;
g) an information management and routing system configured to facilitate communications between the communication device and the user application;
h) system means for discovering the nodes, their interconnection, and modeling the nodes topology; and
i) a user device configured to display information from the user application;
wherein each node of the plurality of nodes is associated with an emergency services sector resource, and is configured to communicate information regarding the emergency services sector resource to the user application via the communications device; and
wherein the user device is configured to display information regarding the emergency services sector resource from the user application.

2. The system of claim 1 wherein the means for collecting information comprises sensors, cameras, observation equipment, and combinations thereof.

3. The system of claim 1 wherein one of the information objects is a map.

4. The system of claim 1 wherein the system for discovering the nodes and modeling the nodes topology is based upon the metadata of the information and provides a time stamp, a source of the information, and an indication of a location on a map and to automatically detect the communication nodes with which to connect.

5. The system of claim 1 wherein the communications device is wireless and the nodes are hierarchically categorized as central nodes and nomadic nodes.

6. The system of claim 1 wherein the communications device is wired and the nodes are hierarchically categorized as central nodes and nomadic nodes.

7. The system of claim 1 wherein the collected information is marked in relation to the disaster or crisis and is assigned to a communication node.

8. The system of claim 1 wherein a complete synchronization is achieved between any central nodes using the system for discovering the nodes and modeling the nodes topology.

9. The system of claim 1 wherein a partial synchronization is achieved between any nomadic nodes using the system for discovering the nodes and modeling the nodes topology and a filtering of the collected information which is marked in relation to the disaster or crisis and assigned to a communication node.

10. The system of claim 1 wherein a partial synchronization is achieved between the central and nomadic nodes using the system for discovering the nodes and modeling the nodes topology.

11. A method for monitoring and managing emergency service resources and for disaster and crisis management using a computer network implemented system comprising:
a) providing at least one server computer having a computer readable medium, the server computer including an information collection utility that enables the computer to collect and store to a database linked to the server computer one or more information objects;
b) providing means for collecting and marking information related to a disaster or crisis;
c) providing at least one communications device configured to establish a network corresponding to that communications device;
d) providing a plurality of communication nodes, each node being connected to the network established by the communications device;
e) providing at least one fixed installation node adapted to model and manage the information collected, connected to said communications device, and capable of functioning as a crisis center;
f) providing a user application comprising software loaded in the computer readable medium at the computing device for execution by a processor;
g) providing an information management and routing system configured to facilitate communications between the communication device and the user application;
h) providing a system means for discovering the nodes, their interconnection, and modeling the nodes topology; and
i) providing a user device configured to display information from the user application;
j) associating each node of the plurality of nodes with an emergency services sector resource;
k) configuring each node to communicate information regarding the emergency services sector resource to the user application via the communications device; and
l) displaying information regarding the emergency services sector resource from the user application.
